(19) United States
(12) Patent Application Publication
(10) Pub. No.: US 2009/0036163 A1
(43) Pub. Date: Feb. 5, 2009

(54) CONTACT EXPIRATION MANAGEMENT

(76) Inventor: Jacob W. Kimbrell, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(21) Appl. No.: 11/832,800

(22) Filed: Aug. 2, 2007

(51) Int. Cl. H04M 1/00; G06F 17/30

(52) U.S. Cl. 455/558; 455/566; 707/204; 707/E17.059

(57) ABSTRACT

A apparatus and method for contact expiration management that includes identifying a contact as temporary, setting an expiration date for the temporary contact, and removing the temporary contact on the expiration date. The apparatus may be a mobile device such as a mobile phone. A user of the mobile device may respond to a prompt and select removing the temporary contacts or the temporary contacts may be removed automatically. A cleanup routine operating on the mobile device monitors time stamps on contacts and expiration dates of contacts to determine when a contact might be removed.

### BACKGROUND OF THE INVENTION

The present invention is related to contacts in a mobile device, and more specifically to contact expiration management.

Many times in a mobile phone or other portable device, a user of the portable device enters contacts into the portable device (e.g., via a phone book or contacts application) that are very seldom used. These contacts may be used for a certain period of time and then are not needed. A user may cleanup their contact list at any time by entering the phone book or contacts list and manually removing temporary, unused or unwanted contacts. However, a lazy user or one that is just extremely busy may have a contacts list grow out of control with unused contacts. This utilizes unnecessary storage on the mobile device as well as makes it more difficult to access desired contacts since the phonebook or contacts list may be cluttered with multiple unused contacts.

### BRIEF SUMMARY OF THE INVENTION

According to one aspect of the present invention, a method for contact expiration management includes identifying a contact as temporary, setting an expiration date for the temporary contact, and removing the temporary contact on the expiration date.

According to another aspect of the present invention, a method for contact expiration management includes identifying a contact as temporary, storing the temporary contact in temporary contact list, and removing the temporary contacts in the temporary contact list.

According to still another aspect of the present invention, a method for contact expiration management includes setting a deletion check date for contacts stored in a mobile device, comparing the deletion check date for each stored contact with a current date, and generating a prompt confirming deletion when the deletion check date for a stored contact is the same as the current date.

According to an aspect of the present invention, a mobile phone includes a display and a keypad, and also includes a memory, the memory storing contacts entered into the mobile phone, and a contact cleanup routine, the contact cleanup routine identifying a contact as temporary, setting an expiration date for the temporary contact, and removing the temporary contact on the expiration date.

According to a further aspect of the present invention, a computer program product comprising a computer useable medium has computer useable program code embodied therewith, the computer useable program code comprising computer useable program code configured to identify a contact as temporary, computer useable program code configured to set an expiration date for the temporary contact, and computer useable program code configured to remove the temporary contact on the expiration date.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of entities and functions that may reside on a mobile device according to an example embodiment of the present invention;

FIG. 2 is a flowchart of a process for setting a contact as temporary when entered according to an example embodiment of the present invention;

FIG. 3 is a flowchart of a process for storing temporary contacts in a temporary storage according to an example embodiment of the present invention;

FIG. 4 is a flowchart of a process for deleting temporary contacts having an expiration date according to an example embodiment of the present invention;

FIG. 5 is a flowchart of a process for monitoring use of contacts according to an example embodiment of the present invention; and

FIG. 6 is a flowchart of a process for identifying contacts associated with an incoming or outgoing call as temporary according to an example embodiment of the present invention.

### DETAILED DESCRIPTION OF THE INVENTION

As will be appreciated by one of skill in the art, the present invention may be embodied as an apparatus, method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention relate to contacts in a mobile device. To help illustrate the present invention, a mobile phone will be used. However, embodiments according to the present invention are not limited to a mobile phone but may be any mobile device (e.g., mobile phone, personal digital assistant (PDA), laptop computer, portable electronic game system, portable music or video player, etc.) and still be within the scope of the present application.

Embodiments according to the present invention allow a user to flag a contact as temporary thereby giving the temporary contact an expiration time at which the contact may be deleted. A contact may typically include, at a minimum, a name and a phone number of an individual, company, group, an alias, an email address, an Instant Messenger (IM) identification, etc. A contact may also be a phone number for a service such as 911, 411, an international operator, etc. For example, a user may enter a contact name “John Doe” and an associated phone number, and mark a temporary flag for the contact denoting the contact is temporary. The flag may be entered by selecting a radio button on a display showing the contact information or by any other method. A cleanup routine executing in the mobile device may prompt the user to enter a time period or date for deletion of the contact (e.g., one week, one month, Jun. 1, 2010, etc.). After the specified deletion or expiration time period, the user may be prompted as to confirm whether this contact “John Doe” should be deleted. The prompt may be a simple message displayed on a screen of the mobile device. Further, embodiments according to the present invention may monitor a time that a contact has been idle or has not been used or accessed, and prompt a user whether this contact should be deleted after a specified idle/non-use time. In this embodiment, each contact may be time-stamped upon entry or last access or use. The time-stamp of each contact, and use of each contact, may then be monitored to determine if the contact has not been used within the specified idle/non-use time, and a prompt generated asking whether the contact should be deleted. According to embodiments of the present invention, a group of contacts may be set as temporary by setting a flag for the group. For example, contacts defined as belonging to a group, for example, “golf buddies”, “siblings”, “contacts at ABC Corp”, “co-workers”, “investment club”, etc. may all have the same expiration date set for the group and be deleted together if the group is set for deletion.

In another embodiment of the present invention, a user may enter the contact into an entirely different (temporary) contact list. This temporary contact list may contain contacts that are to be deleted at some time in the future. This temporary contact list may be integrated into other contact lists such as, for example, a Subscriber Identity Module (SIM) contact list, a phone contact list, etc. However, the temporary contacts list may be recognized as a separate entity for easier management. Moreover, according to embodiments of the present invention, a cleanup routine may delete temporary contacts after a certain expiration time after prompting a user, or may delete the temporary contacts automatically after the expiration time. A user may enter a contact and denote the contact as temporary manually, or when an incoming call is received or an outgoing call is placed, the user may be prompted to enter the associated phone number into a contacts list and at that time indicate whether the contact is temporary.

Further, a cleanup routine may be initiated and executed at a time a user enters into (e.g., opens) a contacts list or phone book, or may be initiated or executed periodically at a specific day/time (e.g., once a day, every Wednesday at 8:00 a.m., etc.), or may run continuously and monitor time stamps on contacts and expiration dates on contacts to determine whether to prompt a user for deletion or automatically delete the contact. A user may determine whether the user desires to be prompted or whether one or more temporary contacts should be automatically deleted. According to embodiments of the present invention, a cleanup routine may get the contacts from a call list (list of recent incoming and outgoing calls) or may create a separate list that the cleanup routine manages. The separate list may be taken from the call list and/or a stored contacts list.

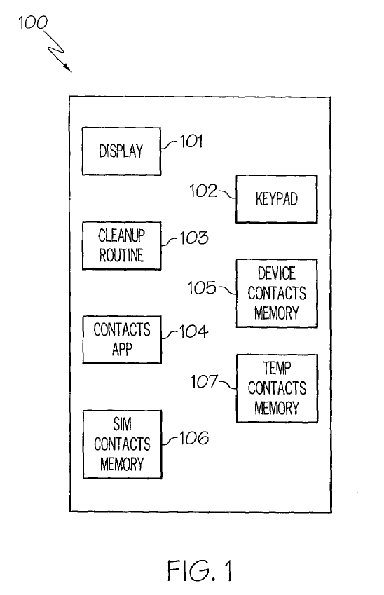

FIG. 1 shows a diagram of entities and functions that may reside on a mobile device according to an example embodiment of the present invention. The mobile device 100 may include a display 101 and a keypad 102. The keypad 102 may be used for entering contacts, responding to prompts, or selecting other functions on the mobile device 100. The display 101 may be a typical Liquid Crystal Display (LCD), or maybe a touch screen display allowing a user to make selections and enter information via the touch screen. Further, the mobile device 100 may include a cleanup routine 103. The cleanup routine may monitor expiration and time stamps of contacts in the mobile device in order to determine whether to prompt a user for deletion of the contact information or to automatically delete the contact information. A contacts application 104 may also be included on the mobile device 100. The contacts application may provide management of stored contacts as well as providing an appropriate interface for a user to enter and make selections regarding contacts entered. The cleanup routine 103 may be a part of the contacts application 104, for example a plug-in, or it may be a separate software application. In embodiments where the cleanup routine 103 is a separate program application, the cleanup routine 103 may operate independently or may operate in coordination with the contacts application 104.

Further, the mobile device 100 may include one or more memories for storing contacts information. For example, a mobile device 100 may include a device contacts memory 105 where the contacts stored in the phone contacts memory 105 are stored in a memory on the mobile device. Further, the mobile device 100 may include a SIM contacts memory 106, where the contacts stored in the SIM memory are stored on a removable SIM card. Moreover, the mobile device 100 may include a temporary contacts memory 107. The temporary contacts memory may be used to store temporary contacts that are to be deleted at some time in the future. The temporary contacts memory 107 may reside on the mobile device 100 or may reside on the SIM card. The mobile device 100 may be any type of mobile device such as, for example, a mobile phone, a personal digital assistant (PDA), a laptop computer, portable electronic game system, portable music or video player, etc.

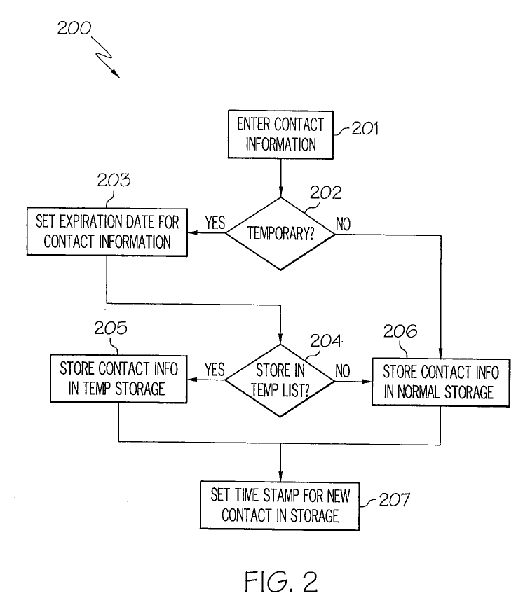

FIG. 2 shows a flowchart of a process for setting a contact as temporary when entered according to an example embodiment of the present invention. In the process 200, in block 201, contact information may be entered into a mobile device by a user. In block 202, it may be determined if the contact is a temporary contact, and if so, in block 203, an expiration date for the contact information may be set. If the contact is not a temporary contact, then in block 206, the contact may be stored in permanent storage (i.e., not a temporary storage). This may be storage residing on the mobile device or storage on a SIM card. If the contact is a temporary contact, in block 204, a prompt may be generated asking the user whether to store the temporary contact into a temporary storage memory. If the user selects to store the contact information in a temporary storage memory, in block 205, the contact information may be stored into the temporary storage memory, and then in block 207, a time stamp may be set for the new contact in the temporary storage. If the user determines to store the contact in permanent storage, in block 206, the contact information may be stored in a permanent (non-temporary) storage such as storage on the mobile device or storage on a SIM card. In block 207, a time stamp may also be set for the new contact in the permanent storage. By setting a time stamp, a user is allowed to specify different methods a cleanup routine may use to clean up undesired or unused contacts. For example, if the user desires to be prompted to delete a contact after inactivity of four months, the time stamp of each contact may be checked to see if it is four months old and the user prompted whether to delete the contact, or the contact may be deleted automatically. If the user does not desire to delete the contact at this time, the contact may be made permanent or the time stamp revised giving the contact another four months.

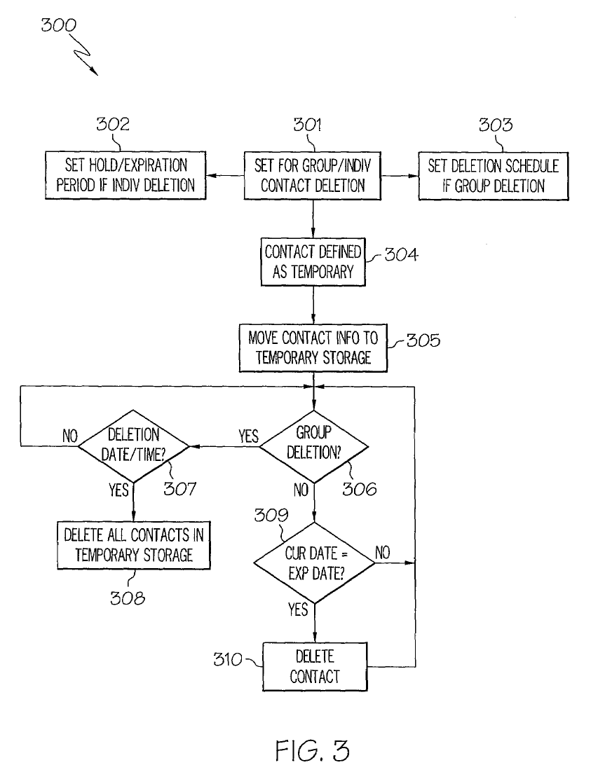

FIG. 3 shows a flowchart of a process for storing temporary contacts in a temporary storage according to an example embodiment of the present invention. The process 300 may include in block 301, a user setting up whether temporary contacts should be deleted as a group or whether temporary contacts should be deleted on an individual basis. If temporary contacts are set to be deleted individually, in block 302, the user may set a holding or expiration period for each individual temporary contact. The expiration period may be any period or time frame, for example, one week, 10 days, one month, etc. If the user sets up temporary contacts for group deletion, in block 303, the user may set a deletion schedule for deletion of all contacts stored in a temporary storage memory. The schedule may be a periodic schedule such as, for example, delete all contacts in temporary storage every day at 8:00 a.m., or delete all contacts in temporary storage every Wednesday at 8:00 a.m., etc.

In block 304, upon entering of a contact or reviewing a contact, a user may define the contact as temporary. In block 305, the contact information may then be stored in a temporary storage. In block 306, a cleanup routine may determine if group deletion has been selected, and if so, in block 307, may determine whether the set deletion schedule date/time has arrived. If the deletion date/time has arrived, in block 308, the cleanup routine may then delete all contacts in the temporary storage. If the deletion date/time has not arrived, the cleanup routine may continue to monitor for the scheduled deletion day/time. If group deletion was not selected by the user, and deletion of individual contacts was selected, in block 309, the cleanup routine may monitor an expiration date associated with each contact in the temporary storage to determine if the current date is the same as the expiration date for the contact. The expiration date may be the time-stamp date of the contact plus the expiration period set by the user. For example, if a contact has a time-stamp date of 2:20 pm, Jan. 19, 2007, and the expiration period is one month, the expiration date for the contact will be 2:20 pm, Feb. 19, 2007. If the expiration date for the contact has not occurred, no deletions will occur and the cleanup routine will continue to monitor. However, if the current date is the same as an expiration date for a particular contact, in block 310, the cleanup routine may then delete the contact.

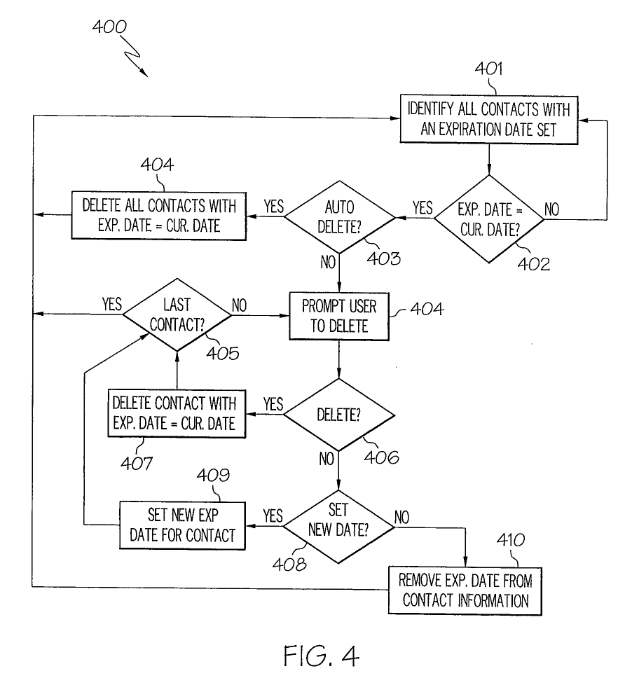

FIG. 4 shows a flowchart of a process for deleting temporary contacts having an expiration date according to an example embodiment of the present invention. In the process 400, in block 401, a cleanup routine may identify all contacts having an expiration date set. In block 402, the cleanup routine may then determine whether an expiration date associated with any contact is the same as a current date, and if not, no deletions occur. If the expiration date on any contact is the same as a current date, the cleanup routine, in block 403, may determine whether auto-deletion has been set, and if so, in block 404, all contacts with the expiration date equal to the current date may be deleted. If auto-deletion has not been set, the cleanup routine, in block 404, may generate a prompt to the user whether to delete the contacts. In block 406, if the user has selected to delete the contacts, then in block 407, each contact with an expiration date equal to the current date may be deleted, and the cleanup routine, in block 405, may determine if this was the last contact, and if not, prompt the user whether to delete the next contact with the expiration date equal to the current date. If the user does not select to delete a particular contact, the cleanup routine, in block 408, may generate a prompt to the user asking the user whether a new expiration date for this contact should be set, and if the user selects to set a new expiration date, in block 409, a new expiration date may be set and stored for the contact, and in block 405, it again determined whether this was the last contact. If the user does not desire to delete the contact or set a new expiration date, the cleanup routine, in block 410, may then remove the expiration date from the contact information therefore making this contact a non-temporary contact.

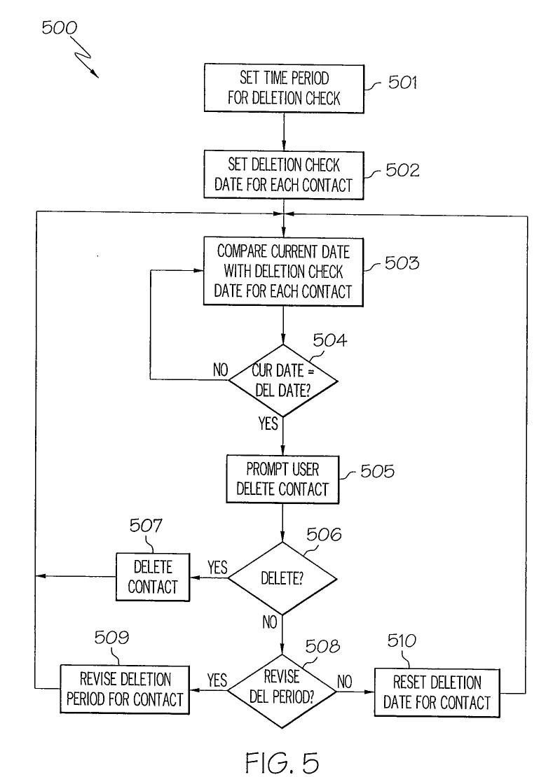

FIG. 5 shows a flowchart of a process for monitoring use of contacts according to an example embodiment of the present invention. In the process 500, in block 501, a time period may be set for a deletion check of contacts stored in a mobile device. In block 502, a deletion check date may be set for each contact. This deletion check date may be based on a time stamp of the contact and the set time period for deletion check. For example, if the set time period for deletion check is one month, and a time stamp for a contact is “10:05 am, Jun. 1, 2007”, the deletion check date for the contact may be set as “10:05 am, Jul. 1, 2007”.

In block 503, a current date may be compared with a deletion check date for each contact. In block 504, the cleanup routine may determine if the current date is the same as a deletion date for any contact, and if not, no deletions may occur. If a current date is the same as a deletion date for a contact, in block 505, the cleanup routine may generate a prompt to the user whether to delete the contact, and in block 506, if the user selects to delete, in block 507, the contact may be deleted, and the process continue. If the user does not select to delete the contact, then in block 508, the cleanup routine may generate a prompt asking the user whether to revise the deletion period for the specific contact, and if the user selects to revise the deletion period, the user may enter a new deletion period, and in block 509, the deletion period for the contact may be revised and stored. If the user does not select to revise the deletion period for the particular contact, in block 510, the cleanup routine may automatically reset the deletion date for the contact based on the current date and the set time period for deletion (e.g., one month).

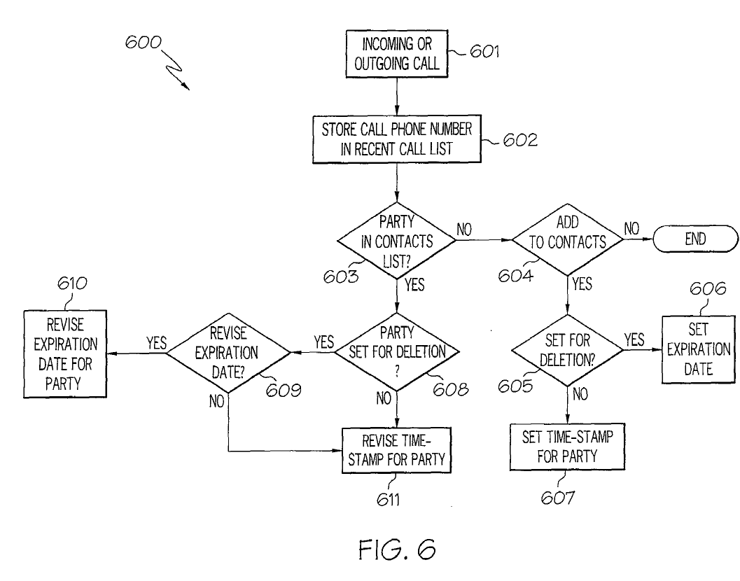

FIG. 6 shows a flowchart of a process for identifying contacts associated with an incoming or outgoing call as temporary according to an example embodiment of the present invention. In the process 600, in block 601, an incoming call may be received or an outgoing call may be generated. In block 602, the incoming or outgoing call phone number may be stored in a recent call list on the mobile device. In block 603, a cleanup routine may determine whether the number associated with the incoming or outgoing call is in a contacts list on the mobile device, and if not, in block 604, the cleanup routine may generate a prompt asking the user whether to add the contact to the contacts list. If the user does not desire to add the contact to the contact list, the process ends. If the user desires to add the contact to the contact list, then in block 605, the cleanup routine may generate a prompt asking the user whether to set this contact for deletion, and if so, in block 606, an expiration date may be set by the user, or by the cleanup routine, for the contact and stored with the contact information. If the user does not desire to set the contact for deletion, in block 607, a time stamp may be associated with the contact and stored with the contact information.

If, in block 603, the cleanup routine determines that the party is in the contacts list, the cleanup routine, in block 608, may determine whether the party has been set for deletion, and if so, in block 609, the cleanup routine may generate a prompt to the user asking whether the expiration date on the contact should be revised. If the user desires to revise the expiration date, the user may then enter a new expiration date for the contact and then, in block 610, the expiration date for the party/contact may be revised and stored with the contact information. If the user does not desire to revise the expiration date, or if the party was not set for deletion, in block 611, the time stamp associated with the contact may be revised to the current date/time of the incoming or outgoing call associated with the contact.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for contact expiration management comprising:
identifying a contact as temporary;
setting an expiration date for the temporary contact; and
removing the temporary contact on the expiration date.

2. The method according to claim 1, further comprising the identifying, the setting, and the removing being performed in a mobile device.

3. The method according to claim 2, further comprising identifying the contact as temporary upon entering the contact into the mobile device

4. The method according to claim 2, wherein the mobile device comprises a mobile phone.

5. The method according to claim 1, further comprising storing the temporary contact and the expiration date.

6. The method according to claim 5, further comprising removing the temporary contact from storage when the expiration date is the same as a current date.

7. The method according to claim 1, further comprising generating a prompt to confirm removal before removing the temporary contact on the expiration date.

8. The method according to claim 1, further comprising automatically removing the temporary contact on the expiration date.

9. The method according to claim 1, further comprising generating a prompt to change the expiration date before removing the temporary contact on the expiration date.

10. The method according to claim 1, further comprising generating a prompt to remove the expiration date before removing the temporary contact on the expiration date.

11. A method for contact expiration management comprising:
identifying a contact as temporary;
storing the temporary contact in temporary contact list; and
removing the temporary contacts in the temporary contact list.

12. The method according to claim 11, further comprising removing all the temporary contacts in the temporary contact list based on a set periodic deletion schedule.

13. The method according to claim 11, further comprising removing individual temporary contacts in the temporary contact list based on an expiration date for each individual temporary contact.

14. The method according to claim 11, further comprising the identifying, the storing and the removing being performed in a mobile device.

15. A method for contact expiration management comprising:
setting a deletion check date for contacts stored in a mobile device;
comparing the deletion check date for each stored contact with a current date; and
generating a prompt confirming deletion when the deletion check date for a stored contact is the same as the current date.

16. The method according to claim 15, further comprising deleting the stored contact based on a response to the generated prompt.

17. The method according to claim 15, further comprising revising the deletion check date for the stored contact based on a response to the generated prompt.

18. The method according to claim 15, further comprising removing the deletion check date for the stored contact based on a response to the generated prompt.

19. A mobile phone, the mobile phone including a display and a keypad, and comprising:
a memory, the memory storing contacts entered into the mobile phone; and
a contact cleanup routine, the contact cleanup routine identifying a contact as temporary, setting an expiration date for the temporary contact, and removing the temporary contact on the expiration date.

20. The mobile phone according to claim 19, wherein the memory comprises at least one of a Subscriber Identity Module (SIM) contacts memory, a temporary contacts memory, and a phone contacts memory.

21. The mobile phone according to claim 19, wherein the contact cleanup routine operates one of once every specified time period, upon entry into a phonebook application, or continuously.

22. The mobile phone according to claim 21, the cleanup routine further determining if a number associated with at least one of an incoming call or an outgoing call is stored in the memory and generating a prompt for storing a contact associated with the number and an associated expiration date in the memory when the number is not stored in the memory.

23. The mobile phone according to claim 21, the cleanup routine further determining if a number associated with at least one of an incoming call or an outgoing call is stored in the memory and generating a prompt for revising an expiration date associated with a contact associated with the number when the number is stored in the memory.

24. A computer program product comprising a computer useable medium having computer useable program code embodied therewith, the computer useable program code comprising:
computer useable program code configured to identify a contact as temporary;
computer useable program code configured to set an expiration date for the temporary contact; and
computer useable program code configured to remove the temporary contact on the expiration date.

25. The computer program product according to claim 24, wherein the computer useable program code operates on mobile device.
